(19) United States
(12) Patent Application Publication
(10) Pub. No.: US 2025/0327597 A1
(43) Pub. Date: Oct. 23, 2025

(54) Tankless water heater, a facility management system, a method for controlling a tankless water heater and a method for operating a facility management system

(71) Applicant: Stiebel Eltron GmbH & Co. KG, Holzminden (DE)

(72) Inventors: Hubert Nolte, Höxter (DE); Frank Stiebel, West Hatfield, MA (US)

(21) Appl. No.: 19/255,454

(22) Filed: Jun. 30, 2025

Related U.S. Application Data
(63) Continuation of application No. 17/130,228, filed on Dec. 22, 2020.

(51) Int. Cl. F24H 9/20; F24H 1/10; F24H 9/14; G05D 23/19

(52) U.S. Cl. CPC F24H 9/2028; F24H 1/102; F24D 2220/042; F24H 9/14; F24H 2250/02; G05D 23/1931

(57) ABSTRACT

A tankless water heater, comprising: a flow channel with a cold-water inlet pipe, a heating unit with an heating element configured to heat water flowing through the heating unit and a hot-water outlet pipe, and a control unit configured to control the tankless water heater, wherein the control unit is configured to receive a power limitation signal of an external facility management system and to control a heating output of the heating element depending on the power limitation signal.

### CROSS-REFERENCE TO RELATED APPLICATIONS

This application is a continuation of U.S. application Ser. No. 17/130,228 filed Dec. 22, 2020, the disclosure of which is hereby incorporated in its entirety by reference herein.

### TECHNICAL FIELD

The present disclosure relates to a tankless water heater, a facility management unit, a method for controlling a tankless water heater and a method for operating a facility management system to control at least two tankless water heaters of an object.

It is noted that citation or identification of any documents in this application is not an admission that such document is available as prior art to the present disclosure.

### BACKGROUND

Point of use water heaters, in particular tankless water heaters, also known as instantaneous water heaters are well known. For example DE 20 2004 012263 U1 describes a tankless water heater in a modular design. Said tankless water heater is equipped with an electronically controlled throttle valve to reduce the flow rate if the desired temperature rise to heat the water exceeds its heating capacity based on the amount of water flowing through the tankless water heater.

Known tankless water heaters can be suitable for installation in bathrooms, shower rooms, toilets or kitchens, for example. Any number of draw-off points can be connected. Possible consumers include bath tubs, showers, washbasins or kitchen sinks.

The water can be heated to a set temperature only on demand, which is to say during draw-off. The available volume of hot water can be affected by a flow rate often specified in the unit [I/min], a cold-water temperature often specified in the unit [° C.], which is the cold-water inlet temperature of incoming water, a heating output often specified in the unit [kW] to heat the incoming water and a required hot-water temperature often specified in the unit [° C.].

The heating capacity of known water heaters can be adequate for the required flow rate and desired temperature rise to accommodate the needs of the user if it has been properly sized. Known tankless water heaters and methods of controlling said tankless water heaters, however, in practice still have room for improvement.

Depending on the region, cold-water temperatures of incoming water can vary considerably in the different seasons. As a result, there can usually be a rather diverse temperature range of average cold-water temperature of incoming water during the different seasons, in particular, there can be a significant difference of cold-water temperatures of incoming water during winter season and summer season. For numerous applications, the tankless water heater can usually provide enough temperature rise during the summer season when the incoming water temperature is high. Often, however, the water heater cannot ensure a sufficient temperature rise during the winter season, in particular, when the incoming water temperature is significantly lower than during summer season.

During summer season the required load of the water heater can preferably be less than during winter season due to a higher cold-water temperature of incoming water at comparable flow rate. In multi apartment house, the simultaneous use of numerous tankless water heaters can preferably cause a problem in the electric supply of said multi apartment house.

### SUMMARY

There is an approach for providing an improved tankless water heater, an improved facility management system, an improved method for controlling a tankless water heater and an improved method for operating a facility management system to control at least two tankless water heaters of an object. In particular, there is an improved solution to reduce disadvantages of known solutions. In particular, there is an approach for providing a solution that is capable of meeting the comfort expectations of users and simultaneously avoid tripping service breaker.

According to a first aspect of the present disclosure, a tankless water heater is suggested. The tankless water heater comprises a flow channel with a cold-water inlet pipe, a heating unit with a heating element configured to heat water flowing through the heating unit and a hot-water outlet pipe, and a control unit configured to control the tankless water heater. The control unit is configured to receive a power limitation signal of an external facility management system and to control a heating output of the heating element depending on the power limitation signal.

In particular, the control unit comprises a control circuit arrangement, which is coupled to the heating element for controlling the heating output. Preferably, the control circuit arrangement can generate a control signal depending on the power limitation signal and transmit said control signal to the heating element.

Preferably, the control unit is configured to reduce a target heating output necessary to control a desired temperature rise to a lower level depending on the power limitation signal. In particular, the control unit is configured to determine the target heating output. Particularly, the control circuit arrangement of the control unit can reduce the target heating output depending on the power limitation signal and determine the target heating output necessary to control a desired temperature rise.

A heating output of the tankless water heater can be significantly responsible for a power consumption of the tankless water heater.

Preferably, the tankless water heater can be connected to a power supply like an electric grid.

The term “external” describes that the facility management system is remote from the tankless water heater. Therefore, the facility management system can be a separate system, which is coupled to the control unit for transmitting signals.

In particular, the control unit can be configured to be coupled wirelessly to the external facility management system, in particular for receiving said power limitation signal.

Particularly, the power limitation signal is generated by the facility management system depending on operating information about simultaneously running tankless water heaters of an object. For example the operating information can comprise information about a number of simultaneously running tankless water heaters or a total current power consumption of the simultaneously running tankless water heaters or both.

The total current power consumption can preferably be a sum of the current power consumptions of the simultaneously running tankless water heaters.

Preferably, the power limitation signal depends on the number of the simultaneously running tankless water heaters of the object. The power limitation signal can preferably depend on a ratio of the number of the simultaneously running tankless water heaters and a specified maximum number of the simultaneously running tankless water heaters.

Alternately or in addition, the power limitation signal depends on a total current power consumption of the simultaneously running tankless water heaters of the object. The power limitation signal can preferably depend on a ratio of the total current power consumption of the simultaneously running tankless water heaters of the object and a specified total maximum power consumption.

“Simultaneously running tankless water heaters” describes running tankless water heaters of the object. Preferably, the control units of the simultaneously running tankless water heaters of the object can be wirelessly coupled to the facility management system.

The term “object” can describe a single apartment house or a multi apartment house with a number of single households. Furthermore, it is to be understood that the term “object” can describe a number of a single apartment houses or a number multi apartment houses as well as a number of a single apartment houses and a number multi apartment houses. Each single apartment house and each single households of the multi apartment house can comprise one or more tankless water heaters. The tankless water heaters of one object can preferably be connected to the facility management system.

Preferably, the heating element is thermally coupled to the water. In particular, different heating elements can be used to heat the water. For example a bare wire heating element or a tubular heater can be used.

Preferably, the control unit can comprise a communication module. The communication module can preferably be or comprise a communication interface, operable to communicate wirelessly with the facility management unit, an external communication unit, a server, a cloud, a power relay or a mobile end device or another communication device. In particular, the communication module enables to have access via mobile end device from around the world and within their local network. For example, the communication module comprises a receiving interface circuit for receiving the power limitation signal or another signal. Preferably, the communication module can comprise a transmitter interface circuit for transmitting signals, in particular operating signals representing operating information to the facility management unit, an external communication unit, a server, a cloud, a power relay or a mobile end device or another communication device.

In particular, the control unit or the control circuit arrangement can comprise a processor and a computer readable memory storing instructions that, when executed by the processor, cause the control unit to control the heating output of the heating element depending on the power limitation signal. In particular, the control unit can receive as input the power limitation signal and provide as output a power setting to the heating element. In particular, the processor can generate a control signal depending on the power limitation signal.

Preferably, the computer readable memory can store a setting temperature set by a user via a user interface. Alternatively or in addition, the computer readable memory can store a setting heating output set by a user via a user interface. In particular, the control unit can be configured to control the heating output depending on the setting temperature or on the setting heating output and on the power limitation signal.

According to an embodiment, the control unit is configured to detect continuously a current heating output and to be coupled wirelessly to the external facility management system for sending a current heating output signal representing the current heating output of the heating element to the external facility management system.

In particular, the current heating output can be time averaged over a time interval. For example the current heating output can represent an average of heating outputs in a time interval, for example of five seconds.

According to an embodiment, the power limitation signal provides a dynamic maximum output value for a dynamic derating. Preferably, the dynamic maximum output value depends on the current operating information, preferably a total current power consumption of simultaneously running tankless water heaters or a number of simultaneously running tankless water heaters connected with the external facility management system. In particular, the dynamic derating can be started, when the total current power consumption of the object exceeds a specified total maximum power consumption or when number of simultaneously running tankless water heaters is higher than a specified maximum number of simultaneously running tankless water heaters.

In an advantageous embodiment of the tankless water heater, a cold-water temperature sensor is arranged at the cold-water inlet pipe and configured to measure a cold-water temperature of incoming water flowing through the cold-water inlet pipe, a flow sensor is configured to measure a flow rate of incoming water flowing through the cold-water pipe and a motor driven throttle valve is foreseen. The control unit is coupled to the cold-water temperature sensor, the flow sensor and the motor driven throttle valve and is configured to calculate a target heating output necessary to control a temperature rise depending on the flow rate and the cold-water temperature of the incoming water and to actively control the motor driven throttle valve to reduce the flow rate depending on the cold-water temperature of the incoming water if the target heating output is higher than a maximum heating output specified by the power limitation signal.

“Arranged at the cold-water inlet pipe” means that the cold-water temperature sensor could be mounted inside the cold-water inlet pipe or outside the cold-water inlet pipe. If it is mounted outside the cold-water inlet pipe this sensor is especially mounted on an outer surface of the cold-water inlet pipe. The cold-water temperature sensor can measure the temperature of incoming water prior to heating by said heating element.

In particular, the tankless water heater further comprises a hot-water temperature sensor arranged at the hot-water outlet pipe and configured to measure a hot-water temperature of outgoing water flowing through the hot-water pipe, wherein the control unit is coupled to the hot-water temperature sensor and is configured to control the motor driven throttle valve for actively controlling the flow rate further depending on the hot-water temperature of the outgoing water in order to assure a constantly accurate temperature delivery.

Preferably, the control unit is configured to control the heating element in order to keep a water temperature to a desired value while a current heating output and thus also a power consumption is reduced to a lower level.

“Arranged at the hot-water inlet pipe” means that the hot-water temperature sensor could be mounted inside the hot-water outlet pipe or outside the hot-water outlet pipe. If it is mounted outside the hot-water outlet pipe this sensor is especially mounted on an outer surface of the hot-water outlet pipe.

The term “temperature” can be associated with the physical temperature of a medium, in particular the temperature of water. The SI unit of temperature is Kelvin (K). In practice the most frequently unit is degree Celsius (° C.) in Europe and degree Fahrenheit (° F.) in the US. It is to be understood, that the cold-water temperature sensor and the hot-water temperature sensor measure temperatures and generate temperature signals as an output signal representing measured temperatures. For example, the hot-water temperature sensor can output a 2V DC signal when measuring a water temperature of 60° C. Therefore, the temperature signal can be used for the input into the control unit or a temperature controller.

In particular, the maximum heating output specified by the power limitation signal can represented by the dynamic maximum output value.

In an advantageous embodiment of the tankless water heater, the control unit is configured to be coupled, in particular wirelessly, to a power relay remote from the tankless water heater to send an activation signal to the power relay for activating the power relay in response to the power limitation signal containing operating information about simultaneously running tankless water heaters in an object connected with the external facility management system to interrupt a power supply to another electricity consumer during a heating process of the tankless water heater.

“In response to the power limitation signal” means that the control unit is configured to activate the power relay depending on receiving the power limitation signal or depending on a flow rate reduction in response to the power limitation signal, wherein the flow rate can be reduced if the target heating output is higher than a maximum heating output specified by the power limitation signal. For example, if the reduced flow rate exceeds a defined value of more than 10% of an initial flow rate the control unit sends the activation signal to the power relay to switch.

In particular, the control unit can be configured to send said activation signal depending on a total power consumption of simultaneous running tankless water heaters of the object or a number of simultaneous running tankless water heaters of the object.

According to an embodiment, the tankless water heater further comprising a metal housing enclosing the flow channel and the control unit, wherein the housing comprises a hole, in which a plastic plug is seated creating a communication window for a wireless communication between the control unit and the external facility management system.

According to a further aspect of the present disclosure, a facility management system for controlling at least two tankless water heaters of an object is suggested. The facility management system for controlling at least two tankless water heaters of an object comprises an intelligent measuring device configured to be coupled to control units of the at least two tankless water heaters and to continuously determine current operating information of the at least two tankless water heaters. The facility management unit further comprises a power management unit coupled with the intelligent measuring device configured to generate and to send a power limitation signal to the control units of the at least two tankless water heaters based on current operating information of the at least two tankless water heaters for controlling heating outputs of heating elements of the at least two tankless water heaters depending on the current operating information of the at least two tankless water heaters.

In particular, the power management unit can be wirelessly coupled with the intelligent measuring device.

Preferably, the power limitation signal can cause the control units to reduce a target heating output necessary to control a desired temperature rise to a lower level depending on the power limitation signal.

In particular, the power management unit is configured to receive the current operating information measured by the intelligent measuring device and to compare the current operating information with set thresholds. Preferably, if the current operating information exceeds said thresholds the power management unit generates and sends the power limitation signal to the control units of the at least two tankless water heaters.

In an advantageous embodiment of the facility management system, the current operating information comprise current power consumptions of the at least two tankless water heaters, wherein the intelligent measuring device is configured to determine a total current power consumption, wherein the power management unit is configured to generate the power limitation signal based on the total current power consumption.

For example, in a case of simultaneously heating of several tankless water heaters in the object a second parameter defined as a threshold declares a maximum total power consumption. If the current total power consumption of simultaneous running tankless water heaters exceeds said threshold the power management unit generates and sends the power limitation signal to the control units of the at least two tankless water heaters.

In an advantageous embodiment of the facility management system, the power management unit is configured to start dynamic deratings of the at least two tankless water heaters by sending the power limitation signal, which specifies a dynamic maximum output value, when said total current power consumption of the object exceeds a specified total maximum power consumption.

In an advantageous embodiment of the facility management system, the current operating information comprise a number of simultaneously running tankless water heaters of the at least two tankless water heaters, wherein the power management unit is configured to generate the power limitation signal based on the number of simultaneously running tankless water heaters of the at least two tankless water heaters.

For example, in a case of simultaneously heating of several tankless water heaters in the object a first parameter defined as a threshold declares a number of simultaneous running tankless water heaters. If the number of simultaneous running tankless water heaters exceeds said threshold the power management unit generates and sends the power limitation signal to the control units of the at least two tankless water heaters.

In an advantageous embodiment of the facility management system, the power management unit is configured to start dynamic deratings of the at least two tankless water heaters by sending the power limitation signal, which specifies a dynamic maximum output value, when said number of simultaneously running tankless water heaters is higher than a specified maximum number of simultaneously running tankless water heaters.

The power limitation of the tankless water heaters can preferably be dynamic and can depend on a continuous comparison between the maximum number of simultaneously running tankless water heaters as a threshold and an actual number of simultaneous running tankless water heaters or the total maximum power consumption as a threshold and an actual current total power consumption of simultaneous running tankless water heaters. Subsequently, the power limitation of the tankless water heaters can be readjusted dynamically, time and result dependent. It shall be achieved that the power limitation is always as low as possible in consideration of the specified total maximum power consumption or the maximum number of simultaneously running tankless water heaters, in order to achieve the lowest possible loss of comfort for the users.

Preferably, the intelligent measuring device can be configured to be coupled to electricity consumers of the object and to continuously determine a total current power consumption of the electricity consumers comprising said current power consumption of the at least two tankless water heaters.

According to an embodiment of the facility management system, the power management unit is cloud-based or server-based.

In particular, the communication between the power management unit, the intelligent measuring device and the control unit can be unidirectional or bidirectional.

According to a further aspect of the present disclosure, a method for controlling a tankless water heater having a heating unit with a heating element configured to heat water flowing through the heating unit and a control unit configured to control the tankless water heater is suggested. The method comprises receiving a power limitation signal of an external facility management system and controlling a heating output of the heating element depending on the power limitation signal.

According to a further aspect of the present disclosure, a method for operating a facility management system to control at least two tankless water heaters of an object is suggested. The method comprises determining current operating information of the at least two tankless water heaters of the object, generating a power limitation signal depending on the current operating information and sending the power limitation signal to control units of the at least two tankless water heaters for controlling heating outputs of heating elements of the at least two tankless water heaters depending on the current operating information of the at least two tankless water heaters.

As to the advantages, preferred embodiments and details of these further aspects and their preferred embodiments, reference is made to the corresponding advantages, preferred embodiments and details described above.

Further advantages of the present disclosure will become apparent when reading the detailed description accompanied by the drawing.

### BRIEF DESCRIPTION OF THE DRAWINGS

Exemplary embodiments shall now be described with reference to the attached drawings, in which

FIG. 1 shows a wireless controlled tankless water heater and

FIG. 2 shows a facility management system.

### DETAILED DESCRIPTION

It is to be understood that the figures and descriptions have been simplified to illustrate elements that are relevant for a clear understanding of the present disclosure, while eliminating, for purposes of clarity, many other elements, which are conventional in this art. Those of ordinary skill in the art will recognize that other elements are desirable for implementing the present disclosure. However, because such elements are well known in the art, and because they do not facilitate a better understanding of the present disclosure, a discussion of such elements is not provided herein.

In the figures, elements with the same or comparable functions are indicated with the same reference numerals.

The present disclosure will now be described in detail on the basis of the exemplary embodiments.

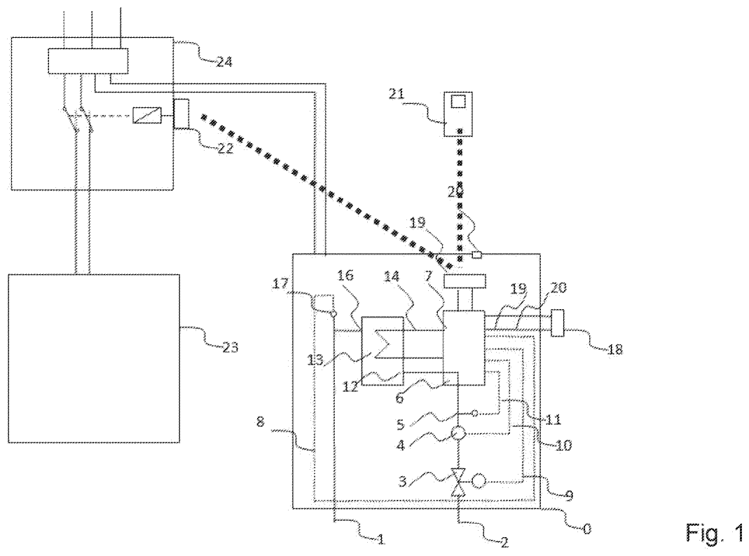

The following explains the concept of a tankless water heater with a wireless communication interface to a power relay (load shed relay) like shown in FIG. 1.

A tankless water heater O metal housing has an outgoing hot water port 1 and inbound water port 2 where the cold water supply is provided. A cold-water inlet pipe connects the inbound water port 2 and a heating unit. A hot-water outlet pipe connects the heating unit and the outgoing hot water port 1. The cold-water inlet pipe, the heating unit with a heating element configured to heat water flowing through the heating unit and the hot-water outlet pipe are parts of a flow channel of the tankless water heater O.

For example, the outgoing water port 1 can be connected to a single or multiple shower heads to supply them with heated water. The shower heads are not shown in FIG. 1.

Downstream of the inbound water port 2 at the cold-water inlet pipe there is a motor driven throttle valve 3, a flow sensor 4 and a cold-water temperature sensor 5 to measure the temperature of incoming cold water prior to heating. Downstream of the heating unit there is a hot-water temperature sensor 17 to measure the temperature of outgoing heated water. The motor driven throttle valve 3, the flow sensor 4, the cold-water temperature sensor 5 and the hot-water temperature sensor 17 are coupled to a control unit 7 of the tankless water heater. The control unit 7 can comprise an electronic control board and the motor driven throttle valve 3, the flow sensor 4, the cold-water temperature sensor 5 and the hot-water temperature sensor 17 can be coupled with the electronic control board via wires 8-11.

Not shown is the connection of the tankless water heater O to a power supply like an electric grid. For an electric tankless water heater a part of the cold-water inlet pipe 6 is required to cool the power triacs component of the electronic control board. The electronically controlled power triacs (not shown in FIG. 1) can define the heating output of the tankless water heater necessary to control a desired temperature rise at different flow rates and different incoming water temperatures.

The shown heating unit comprises a heat exchanger vessel 13 and a heat exchanger 14. The incoming cold water enters at port 12 of the heat exchanger vessel 13 and is heated by the heat exchanger 14. The heat exchanger 14 can be a sheathed electric element or an electrically heated bare wire heating system. The heated water passes the vessel 13 and leaves at port 16. The temperature of the heated water is detected by the hot-water temperature sensor 17 to capture the temperature of the outgoing heated water, preferably based on a temperature set via a knob or push button below the display 18. The knob 18 is shown on the front casing in FIG. 1.

It has been found useful if the tankless water heater O comprises a user interface receiving a user input, for example with regard to the set temperature value and providing the set temperature value to the control unit 7. The user interface can be a temperature set point device, for example. If necessary the installer of the tankless water heater can do a setup using the user interface, preferably the display push button, to declare specific thresholds or a maximum heating output.

An electronic communication module 19 is connected to the electronic control board 7 to communicate wirelessly with a an external communication device 21 remote from the tankless water heater O. The external communication device can preferably be a smart phone, a tablet, an user interface unit, a facility management system or the power relay.

Due to the fact that the broadcasting process is suppressed by the metal housing of the heater, a plastic plug 20 seated in a hole in the metal housing in front of the communication module 19 creates a communication window to interrupt the effect of a Faraday cage in order to insure a proper communication between the external communication device 21 and the communication module 19.

During the winter season when the temperature of the incoming water declines, at a higher flow rate and required temperature rise, the heating capacity provided by the heater may be exceeded. The control unit 7 can automatically calculate steps for the throttle valve 3 to reduce the flow rate until the desired temperature rise is achieved at the maximum heat capacity the heater is able to provide. This ensures the comfort of a suitable flow rate even at low incoming water temperatures.

During the summer season when the incoming water temperature increases the desired temperature rise is smaller and the throttle valve 3 opens fully to provide the maximum flow rate.

Preferably information from the flow sensor 4, the activation of the throttle valve 3, and the firing rate of the triacs providing energy to the heating element are able to send an activation signal to a remote controlled power relay placed in a mains terminal to terminate the power supply to other electricity consumers in an apartment during the shower event.

If necessary the installer of the heater can do a setup using the display push button 18 to declare specific power threshold parameter. The power threshold values may depend on the current power usage of the water heater, and or on a defined period of time. The activation of the power relay may also depend on an event like the number of simultaneously running water heaters in a multi apartment house or the total current power consumption of the simultaneously running water heaters.

For example, a first parameter declares a first power rate. If the required heating output to heat up the water exceeds the first power rate the throttle valve 3 is closed slightly to reduce the flow rate while detecting the flow rate difference according to the sensor information of the flow sensor 4. The control unit 7 keeps the water temperature to the desired value while the power consumption is reduced to a lower level declared with the first parameter. If the flow restriction exceeds a defined value of more than 10% of the former flow rate the communication module 19 sends a signal to the power relay 22 to switch.

In a case of simultaneously heating of several water heaters in a multi apartment building a second parameter declares a number of simultaneous running tankless water heaters. If the number of simultaneous running tankless water heaters exceeds the threshold of the second parameter the control unit 7 keeps the water temperature to the desired value while the power consumption is reduced to a lower level declared particularly with the first parameter. If the flow restriction exceeds a defined value of more than 10% of the former flow rate the communication module 19 sends a signal to the power relay 22 to switch the power relay.

The power relay disconnects an electricity consumer 23 like a kitchen oven or a AC system temporarily from the power supply during a heating process of the tankless water heater to reduce the power demand of the single apartment to a defined threshold value. Once the shower event is done the power relay switches to activate the power supply to the electricity consumer 23. The power relay can be placed attached or close to the main terminal 24.

If a tankless water heater do not have a throttle valve 3 and is not connected to a power relay 22 the load shed can be performed in the following way. Alternatively, the following load shed can be additional to the method described above.

Each single tankless water heater of at least two tankless water heaters of an object like a multi apartment building can detect continuously the current heating output to heat up the water during a tapping event. In a case of simultaneously heating of several tankless water heaters in the object a second parameter defined by the installer of the water heater declares a number of simultaneous running wireless connected water heater. If the number of simultaneous running heater exceeds the threshold of the second parameter the control unit 7 reduces the current power consumption of all tankless water heaters by a factor declared with a third parameter. The third parameter can preferably be a derating parameter in percent of the current power consumption of each heater. If the value of the third parameter is for example 0.9 the current power consumption of each heater is reduced by 10%. This ensures that the lack of comfort by the derating of the heater group is minimized.

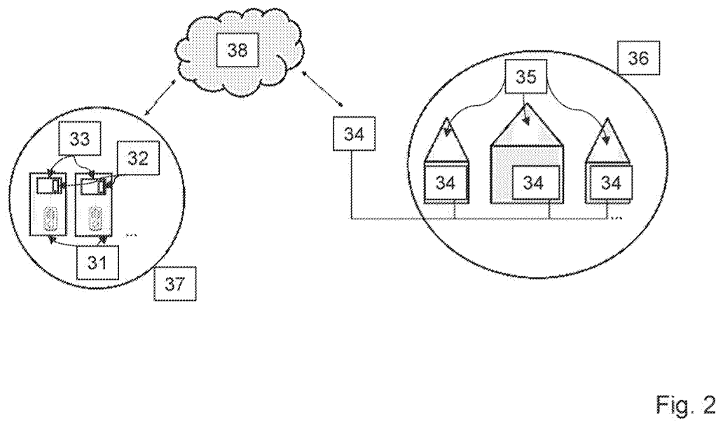

FIG. 2 shows a facility management system. Electronic tankless water heaters 31 are equipped with a control unit 33 comprising a communication module 32. The communication module can be coupled wired or wireless with an control circuit arrangement of the control unit.

The electronic control unit 33 of the tankless water heater 31 can continuously detect the current heating output to heat up the water during a tapping event. The maximum power consumption can be determined, for example by a selected capacity, for units with selectable capacity, or by the available rated capacity, for units with fixed capacity.

An intelligent measuring device 34 can continuously detect the current power consumption of an object 35, 36.

All tankless water heaters installed in an object 35, 36 are combined to a virtual device cluster 37.

When the current power consumption of the object 35, 36 exceeds a defined threshold value, the dynamic derating process of the flow heaters starts. Subsequently, all simultaneous running tankless water heaters receive a power limitation signal from the server or the cloud 38 to limit the power by specifying a dynamic maximum output value.

The communication between the server or the cloud 38, intelligent measuring device 34 and communication module 32 can be uni- or bidirectional. Via the communication module 32, the control unit 33 of the tankless water heater 31 receives information about a maximum permissible actual power consumption.

When all simultaneous running tankless water heaters fall below the defined threshold value of the power consumption, the dynamic derating process can be terminated again.

While this disclosure has been described in conjunction with the specific embodiments outlined above, it is evident that many alternatives, modifications, and variations will be apparent to those skilled in the art. Accordingly, the preferred embodiments as set forth above are intended to be illustrative, not limiting. Various changes may be made without departing from the spirit and scope of the disclosure as defined in the following claims.

What is claimed is:

1. A tankless water heater, comprising:
a flow channel with a cold-water inlet pipe, a heating unit with a heating element configured to heat water flowing through the heating unit and a hot-water outlet pipe, and
a control unit configured to control the tankless water heater,
wherein the control unit is configured to receive a power limitation signal of an external facility management system and to control a heating output of the heating element depending on the power limitation signal.

2. The tankless water heater according to claim 1, wherein the control unit is configured to detect continuously a current heating output and to be coupled to the external facility management system for sending a current heating output signal representing the current heating output of the heating element to the external facility management system.

3. The tankless water heater according to claim 1, wherein the power limitation signal provides a dynamic maximum output value for a dynamic derating.

4. The tankless water heater according to claim 1, further comprising:
a cold-water temperature sensor arranged at the cold-water inlet pipe and configured to measure a cold-water temperature of incoming water flowing through the cold-water inlet pipe,
a flow sensor configured to measure a flow rate of incoming water flowing through the cold-water pipe and
a motor driven throttle valve,
wherein the control unit is coupled to the cold-water temperature sensor, the flow sensor and the motor driven throttle valve and is configured to calculate a target heating output necessary to control a temperature rise depending on the flow rate and the cold-water temperature of the incoming water and to actively control the motor driven throttle valve to reduce the flow rate depending on the cold-water temperature of the incoming water if the target heating output is higher than a maximum heating output specified by the power limitation signal.

5. The tankless water heater according to claim 1, wherein the control unit is configured to be coupled to a power relay remote from the tankless water heater to send an activation signal to the power relay for activating the power relay in response to the power limitation signal containing operating information about simultaneously running tankless water heaters in an object connected with the external facility management system to interrupt a power supply to another electricity consumer during a heating process of the tankless water heater.
